(19) United States
(12) Patent Application Publication
(10) Pub. No.: US 2007/0084795 A1
(43) Pub. Date: Apr. 19, 2007

(54) Method and system for treating wastewater

(76) Inventor: Edward J. Jordan, Lenexa, KS (US)

Correspondence Address: LOWRIE, LANDO & ANASTASI, LLP;U0105, 1 MAIN ST., SUITE 1100, CAMBRIDGE, MA, 02142, US

(21) Appl. No.: 11/543,005

(22) Filed: Oct. 4, 2006

Related U.S. Application Data
(60) Provisional application No. 60/723,746, filed on Oct. 5, 2005.

(51) Int. Cl. C02F 1/44

(52) U.S. Cl. 210/652

(57) ABSTRACT

The invention is directed to controlling wastewater treatment system operations in response to a demand associated with the influent conditions. Fluctuations or variations in flow and/or concentration characteristics of the liquid to be treated can create the reduce the operating demand and the treatment system can be operated to a reduced or standby operating mode by adjusting the operation of one or more unit operations or subsystems in response to such variations. The wastewater system can also be operated to treat an anticipated wastewater stream based on the historical characteristics of the stream.

### CROSS-REFERENCE TO RELATED APPLICATIONS

This application claims priority under 35 U.S.C. § 119(e) to U.S. Provisional Application Ser. No. 60/723,746, entitled “METHOD AND SYSTEM FOR TREATING WASTEWATER,” filed on Oct. 5, 2005, which is herein incorporated by reference in its entirety.

### BACKGROUND OF INVENTION

1. Field of Invention

This invention relates to treating wastewater and, in particular, to controlling a wastewater treatment system based on an amount or rate of wastewater to be treated.

2. Discussion of Related Art

Treatment systems can separate water from solids in wastewater producing purified water and sludge. Treatment systems are designed and constructed based on a nominal capacity and are conventionally operated at the nominal condition.

### SUMMARY OF THE INVENTION

In accordance with one or more embodiments, the invention relates to a method of treating wastewater. The method can comprise acts of measuring a flow rate of the wastewater into a vessel, immersing a membrane module in the wastewater, air scouring the membrane module; and regulating a rate of air scouring in proportion to the flow rate of the wastewater.

In accordance with one or more embodiments, the invention relates to a wastewater treatment system. The treatment system can comprise a vessel containing the wastewater, a membrane module immersed in the wastewater, a flow meter fluidly connected between the vessel and a source of the wastewater, an aeration system disposed to air scour the membrane module, and a controller in communication with the flow meter and the aeration system, and configured to generate a control signal that adjusts a rate of air scouring in proportion to a flow rate of the wastewater introduced into the vessel.

In accordance with one or more embodiments, the invention relates to a wastewater treatment system. The wastewater treatment system can comprise a pump disposed to introduce the wastewater into a treatment vessel, a membrane module disposed in the treatment vessel, an aeration system disposed to air scour the membrane module, and a controller in communication with the pump and the aeration system and configured to regulate a rate of air scouring in proportion to a flow rate of the wastewater introduced into the treatment vessel.

In accordance with one or more embodiments, the invention relates to a computer-readable medium having computer-readable signals stored thereon that define instructions that, as a result of being executed by a computer, instruct the computer to perform a method of controlling a wastewater treatment system. The method can comprise acts of receiving an input signal representative of a flow rate of the wastewater into the treatment system, air scouring the membrane module, and regulating a rate of air scouring based at least partially on the input signal.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram illustrating one or more components or subsystems of the invention;

FIG. 2 is a schematic diagram illustrating a treatment system in accordance with one or more embodiments of the invention;

FIG. 3 is a schematic diagram illustrating a computer system upon which one or more embodiments of the invention may be practiced; and

FIG. 4 is a schematic illustration of a storage system that may be used with the computer system of FIG. 3 in accordance with one or more embodiments of the invention.

### Definitions

As used herein, the term “plurality” refers to two or more items or components.

The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims.

### DETAILED DESCRIPTION

This invention is not limited in its application to the details of construction and the arrangement of components set forth in the following description or illustrated in the drawings. The invention is capable of embodiments and of being practiced or of being carried out in various ways beyond those exemplarily presented herein.

The invention is directed to wastewater treatment systems. Some aspects of the invention relate to controlling or regulating one or more unit operations or subsystems of wastewater treatment systems. Aspects relative to one or more embodiments of the invention are directed to responding to a demand imposed on the wastewater treatment system and adjusting the operation of one or more unit operations or subsystems of the wastewater treatment system. For example, some aspects of the invention can accommodate fluctuations or variations in flow and/or concentration characteristics of the liquid to be treated. Indeed, in some cases, the wastewater system can be advantageously operated to treat an anticipated wastewater stream based on historical characteristics.

The various operating modes of the unit operations or components of the wastewater treatment responsive to the stimuli, triggers, parameters or conditions of the treatment system can reduce or otherwise modify an operating characteristic of the treatment system. For example, the operating characteristic can be related to the efficiency and/or extent of recovery achieved by the treatment system. In some embodiments of the invention, the operating characteristic can be related to the operating life and/or reliability of one or more components or subsystems of the treatment system. In still other embodiments of the invention, the operating characteristic may be related to operation factors, such as the operating costs associated with the treatment system. Notably, in some embodiments of the invention, the operating characteristic can be related to a combination of the above-mentioned aspects. The systems and techniques of the invention can be utilized to adjust one or more operating parameter based on or in response to a stimuli or condition during treatment operations.

The treatment system can comprise a plurality of stations or unit operations arranged to purify or at least reduce a concentration of one or more undesirable species from the wastewater to be treated. Such stations or unit operations can be configured to interact with other stations or unit operations of the treatment system during operation thereof. In some embodiments of the invention, the treatment system can comprise a first subsystem that receives the wastewater to be treated, also referred to herein as “influent,” and a second subsystem, which, in some cases, can comprise a plurality of unit operations that can remove or at least reduce the concentration of the one or more undesirable species. For example, the second subsystem can comprise one or more filtration systems or devices that can selectively separate components of the wastewater. Thus in accordance with some embodiments of the invention, the second subsystem can separate one or more solid components from a liquid component of the wastewater. The treatment system can further comprise a third subsystem that can monitor, provide, and/or modify a condition or characteristic of any one or more of the other subsystems, or subcomponents thereof, of the treatment system and/or a condition or characteristic of the wastewater, components of the wastewater, and/or products of the treatment process.

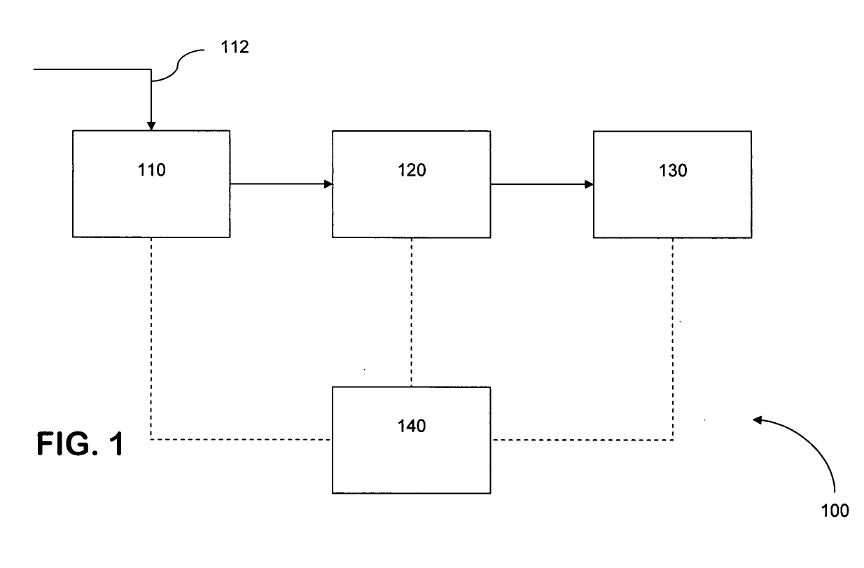

As exemplarily illustrated in FIG. 1, some treatments systems 100 of the invention can comprise an optional first stage 110 that receives influent 112 to be treated from a wastewater source (not shown) and a second stage 120 that effects separation or treatment of the influent into components thereof. Treatment system 100 can also optionally comprise a third stage 130 disposed to receive at least one or more products or separated components from second stage 120. Treatment system 100 can further comprise a regulating system 140 that receives, analyzes, and/or generates one or more parameters from or to any one or more of stages 110, 120, and 130 or components thereof.

First stage 110 can include one or more unit operations that regulates, monitors, and/or provides representations of one or more conditions or characteristics of the influent introduced to second stage 120. In some embodiments of the invention, stage 110 can further comprise one or more unit operations that can accumulate or otherwise store the influent, at least temporarily, and, in some cases, further provide motive energy to effect delivery of the influent to second stage 120. Thus, in some cases, first stage 110 can comprise devices, and/or subsystems that can measure and/or provide a characteristic or an indication of a condition of the influent. For example, first stage 110 can comprise one or more measurement devices that can measure or otherwise provide a representation of any one or more a temperature, specific gravity, flow rate, conductivity, oxidation potential, turbidity and/or a concentration of one or more components of the influent. First stage 110 can further comprise a reservoir or vessel that receives or accumulates influent from the wastewater source and/or one or more unit operations that provides head pressure to facilitate influent transfer to second stage 120. Some embodiments of the invention, moreover, can involve a combination of such functionalities. For example, first stage 110 can comprise a pump that pressurizes the influent and facilitates transfer thereof to second stage 120. The pump can comprise one or more subcomponents or ancillary devices that provides an indication or representation of the flow rate of the influent therethrough and/or any other desirable parameter or characteristic of the influent.

Second stage 120 can comprise one or more separation systems as well as subsystems or subcomponents thereof that facilitate treatment of the influent to reduce a concentration of one or more undesirable species. In some embodiments of the invention, for example, second stage 120 can comprise one or more filtration unit operations that can separate a liquid phase from a solid phase of the influent. Any suitable filtration system can be utilized to effect or perform the one or more separation operations. Indeed, a combination of various techniques can be utilized to separate components or phases of the influent. For example, second stage 120 can comprise one or more membrane modules having at least one porous membrane that can prevent or at least inhibit a solid component while allowing a liquid component to transport therethrough. Other techniques that may be utilized in second stage 120 include, but are not limited to, reverse osmosis, ultrafiltration, microfiltration, and precipitation processes.

Third stage 130 may comprise any receive, for example, one or more components or products of second stage 120. In some embodiments of the invention, third stage 130 can comprise systems or utilize techniques that can facilitate operation or performance of second stage 120. In some cases, third stage 130 can comprise one or more unit operations that effects withdrawal of a separated component of the influent. Thus, for example, stage 130 can comprise one or more suction pumps and other devices that facilitates withdrawal of, for example, a product of stage 120, also referred to herein as effluent or permeate, depending on the technique utilized to produce such product.

Regulating system 140 can comprise a plurality of subsystems that can affect control of one or more characteristics or conditions of any component of the treatment system. For example, system 140 can comprise a controller as well as ancillary components thereto that can facilitate regulation of at least one operation of the treatment system.

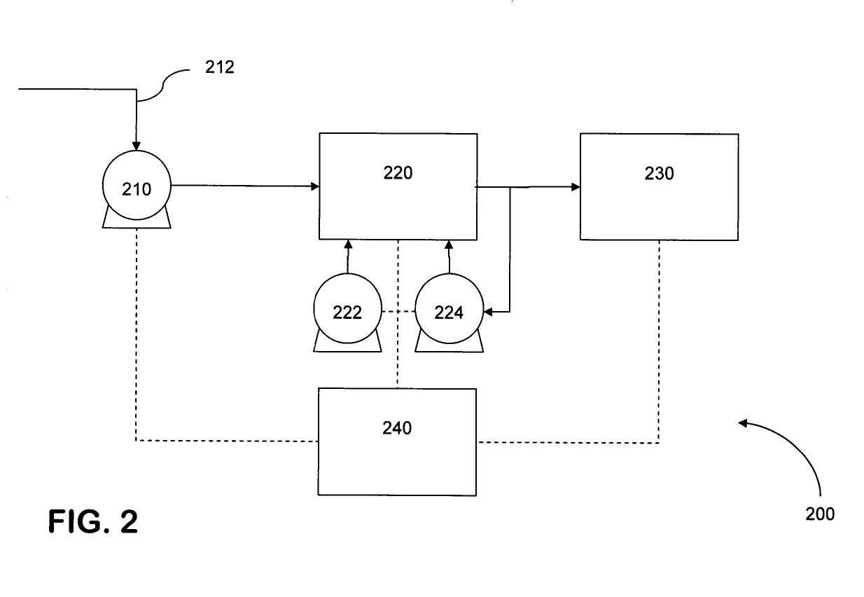

Some aspects of the invention can be particularly directed to controlling wastewater treatment operations that utilize membrane filtration techniques. For example, with reference to FIG. 2, a wastewater treatment system 200 can comprise a first component 210 that facilitates delivery of the influent 212 to a membrane module 220 wherein the wastewater is purified to produce a permeate, a treated water stream that is substantially free of solids. The membrane modules typically contain a plurality of porous or permeable fiber membranes. Such membrane filtration systems typically require backwashing to maintain filtration effectiveness and flux capacity. Other techniques directed at reducing transmembrane pressure across an the membrane wall typically include directing bubbles, also referred to as air scouring, as well directing stream of liquid at the outer membrane surfaces. The latter, recirculation flow, typically involves withdrawing a portion of the bulk wastewater fluid and directing a stream, e.g., jet streaming, to the external surfaces of, for example, the porous or liquid-permeable fibers with one or more pumps 224 in, for example, a recirculation system.

Air scouring typically involves pumping and/or compressing air with, typically one or more pumps, blowers or aerators 222 into the membrane module. Wastewater contains a high concentration of solids and soluble substances. These substances and solids may partially or completely clog membrane pores, building a concentration polarization layer as water is transported through the membrane. Air scouring and recirculation flow can enhance turbulence of the bulk fluid and backward mass transfer to the solids and soluble substances by air-lifting effects, vibration, and cross-flow phenomena. Thus, in effect, air scouring and/or recirculation flow can reduce pore clogging and concentration polarization on the membrane surface by facilitating backward mass transfer to the bulk liquid phase.

Because, as discussed, influent conditions may periodically vary, the invention can react to such variations to advantageously reduce operating requirements. Indeed, the invention can advantageously anticipate operational demand variations to optimize or at least reduce treatment requirements, e.g., reduce operating costs.

Typical operation at high flux rates of treatment systems such as membrane filtration systems involve operating for relatively short periods, about four hours, during peak influent flow, without a change in air scour or recirculation rates. A high or peak flux treatment system operating condition, e.g., about 23.5 GFD, can have an associated air scouring rate of between about 1 to about 2 cfm per 100 ft² of membrane and a recirculation rate of about two to about seven gallons per minute per 100 ft² of membrane during such high flux rates, for about four hours. Under such an operating mode, fouling of the membranes may increase depending on the impurities or solids loading of the wastewater stream, but will likely recover after returning to a nominal design, or normal flux load. In this example, the ratio of air scour to flux can be represented as 23.5/1.6=14.68, at a peak flux condition, and 15/1.6=9.375, at a normal or design flux condition (referred to as the target air scouring ratio). Accordingly, some aspects of the invention can be implemented to seek operation at the normal air scouring ratio to reduce operating loads. For example, where an influent flow rate is less than the design condition, the air scouring rate can be proportionally adjusted to achieve the target air scouring ratio. Other techniques directed at modifying a setpoint for air scouring and directing recirculating flow can also be utilized. For example, a target air scouring rate can be utilized as control set point by considering the flux through the treatment system as well as other characteristics or properties of the influent, effluent, or both.

Analogously, a design or normal operating water recirculation ratio can be defined as 15/5=3 and a peak recirculation ratio can be defined as 23.5/5=4.7. Accordingly, further aspects of the invention can be implemented to achieve the target recirculation ratio to reduce operating loads where desired. For example, where an influent flow rate is less than the design condition, the water recirculation ratio can be proportionally adjusted to achieve the target, e.g., target, recirculation ratio.

Moreover, other variations to performing the control scheme can be utilized including, but not limited to, proportionality constants, deadband or lead/lag protocols to stabilize control behavior. Notably, various control technique may further be advantageously utilized to augment the response characteristics relative to the demand. Thus, one or more embodiments of the invention can utilize an anticipated behavior, e.g., a diurnal nature, of the influent and the control system of the invention can apply fuzzy logic techniques to reduce variations in treated effluent properties.

In accordance with further aspects pertinent to one or more embodiments of the invention, additional techniques may be utilized to further enhance treatment processes. One or more techniques directed at cleaning or regenerating the treatment system may be utilized during modified operations, during operating conditions at other than normal or design operating loads. For example, air bursting and/or jet streaming actions may be performed after a predetermined period or duration. Such ancillary techniques can create or increase turbulent conditions at regions proximate, for example, the active filtration interfaces. Air burst scouring can involve, for example, disengaging any imposed proportional limitation on the aerator system thereby providing increased, full or 100%, air scouring rate to the membrane module. Similarly, jet streaming can involve any technique that increases the volume and/or liquid pressure directed to the active membrane surfaces. The duration of the air burst and/or jet streaming can vary and be based on, for example, the duration of the modified operation, the total service life of the membrane, the condition or concentration of solids in the wastewater, and even the time interval between air bursting and/or jet streaming, as well as combinations thereof. For example, for a treatment system designed to have a peak flux capacity of 23.5 GFD, air bursting and/or jet streaming, for about 5 to about 20 seconds, can be optionally performed during a modified operating flux rate of about 15 GFD; performed after about seven minutes during a modified operating flux rate of about 10 GFD; performed after about five minutes during a modified operating flux rate of about 5 GFD; and performed after about two minutes during a modified operating flux rate of about 2 GFD.

Moreover, some embodiments of the invention can be directed to monitor a rate of change of treatment system performance and trigger one or more operations directed at improving, where appropriate, the system performance. With reference to FIG. 1, any of station 110, 120, and 130 can provide an indication of performance of the treatment system by monitoring and providing a representation thereof to controller 140, which in turn, initiates or modifies one or more unit operations of the treatment system. Thus, some embodiments of the invention can be directed to a feedback loop including one or more sensing stations or devices, one or more controllers, and one or more actuated or modified parameters. Such control loops can further utilize schemes based on deadband, proportional, proportional, integration, derivative techniques, as well as combinations thereof. Accordingly, with reference to FIG. 2, controller 240 can receive an input signal from any of pump 210 and station 230 to actuate or modify the operation of the aeration system and/or the recirculation system to enhance treatment recovery. Station 230 can be any device that provides a direct or indirect indication, e.g. a rate of change, of the operation of the treatment system and can include, for example, sensors or composition analyzers that measure any of pH, conductivity, turbidity, concentration, density or specific gravity, and viscosity.

Further embodiments of the invention can involve reducing treatment system operations to a standby condition where, for example, an imposed demand allows minimal operating or during extended periods of low influent flow rate, e.g., less than about 50%, or even less than about 25%, of nominal or design treatment system capacity. During such standby modes, air scouring, air bursting, recirculation, and/or jet streaming can be intermittently performed according to a predetermined or proportional schedule. For example, only air bursting, for about five to about twenty seconds every about twenty minutes of standby mode operation, can be utilized.

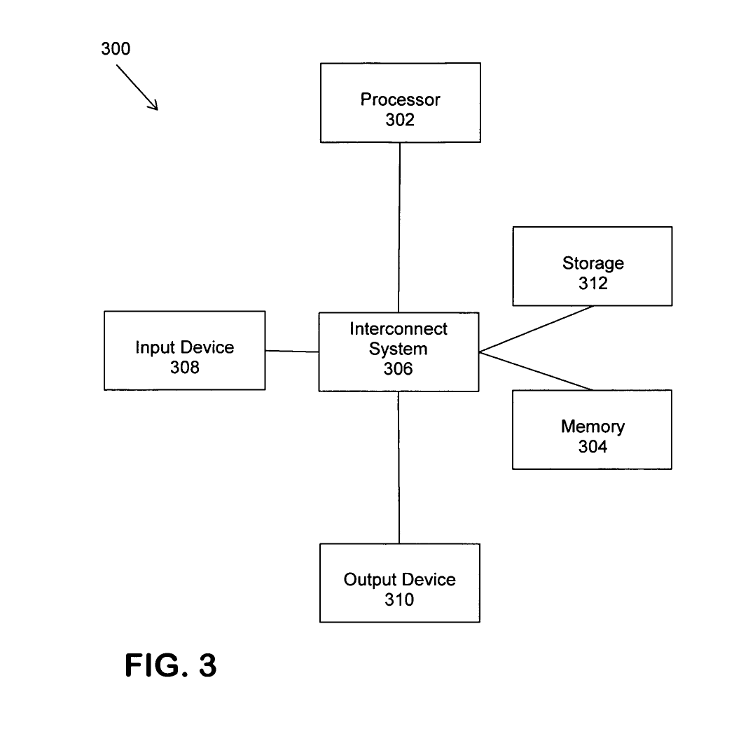

The controller of the system of the invention 140 may be implemented using one or more computer systems 300 as exemplarily shown in FIG. 3. Computer system 300 may be, for example, a general-purpose computer such as those based on an Intel PENTIUM®-type processor, a Motorola PowerPC® processor, a Sun UltraSPARC® processor, a Hewlett-Packard PA-RISC® processor, or any other type of processor or combinations thereof. Alternatively, the computer system may include specially-programmed, special-purpose hardware, for example, an application-specific integrated circuit (ASIC) or controllers intended for water treatment system.

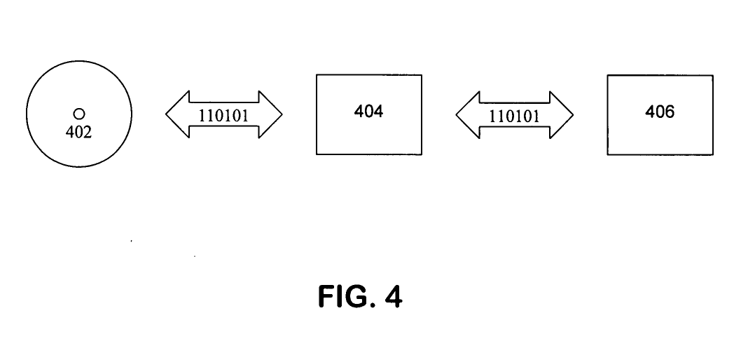

Computer system 300 can include one or more processors 302 typically connected to one or more memory devices 304, which can comprise, for example, any one or more of a disk drive memory, a flash memory device, a RAM memory device, or other device for storing data. Memory 304 is typically used for storing programs and data during operation of the system 100 (or 200) and/or computer system 300. For example, memory 304 may be used for storing historical data relating to the parameters over a period of time, as well as operating data. Software, including programming code that implements embodiments of the invention, can be stored on a computer readable and/or writeable nonvolatile recording medium (discussed further with respect to FIG. 4), and then typically copied into memory 304 wherein it can then be executed by processor 302. Such programming code may be written in any of a plurality of programming languages, for example, Java, Visual Basic, C, C#, or C++, Fortran, Pascal, Eiffel, Basic, COBAL, or any of a variety of combinations thereof.

Components of computer system 300 may be coupled by one or more interconnection mechanisms 306, which may include one or more busses (e.g., between components that are integrated within a same device) and/or a network (e.g., between components that reside on separate discrete devices). The interconnection mechanism typically enables communications (e.g., data, instructions) to be exchanged between components of system 300.

Computer system 300 can also include one or more input devices 308, for example, a keyboard, mouse, trackball, microphone, touch screen, and other man-machine interface devices as well as one or more output devices 310, for example, a printing device, display screen, or speaker. In addition, computer system 300 may contain one or more interfaces (not shown) that can connect computer system 300 to a communication network (in addition or as an alternative to the network that may be formed by one or more of the components of system 300).

According to one or more embodiments of the invention, the one or more input devices 308 may include sensors for measuring parameters of system 200 and/or components thereof. Alternatively, the sensors, the metering valves and/or pumps, or all of these components may be connected to a communication network (not shown) that is operatively coupled to computer system 300. For example, one or more stages 110, 120, and 130, and/or components thereof, may be configured as input devices that are connected to computer system 300. Any one or more of the above may be coupled to another computer system or component to communicate with computer system 300 over one or more communication networks. Such a configuration permits any sensor or signal-generating device to be located at a significant distance from the computer system and/or allow any sensor to be located at a significant distance from any subsystem and/or the controller, while still providing data therebetween. Such communication mechanisms may be effected by utilizing any suitable technique including but not limited to those utilizing wireless protocols.

As exemplarily shown in FIG. 4, controller 300 can include one or more computer storage media such as readable and/or writeable nonvolatile recording medium 402 in which signals can be stored that define a program to be executed by one or more processors 302. Medium 402 may, for example, be a disk or flash memory. In typical operation, processor 302 can cause data, such as code that implements one or more embodiments of the invention, to be read from storage medium 402 into a memory 404 that allows for faster access to the information by the one or more processors than does medium 402. Memory 404 is typically a volatile, random access memory such as a dynamic random access memory (DRAM) or static memory (SRAM) or other suitable devices that facilitates information transfer to and from processor 302.

Although computer system 300 is shown by way of example as one type of computer system upon which various aspects of the invention may be practiced, it should be appreciated that the invention is not limited to being implemented in software, or on the computer system as exemplarily shown. Indeed, rather than implemented on, for example, a general purpose computer system, the controller, or components or subsections thereof, may alternatively be implemented as a dedicated system or as a dedicated programmable logic controller (PLC) or in a distributed control system. Further, it should be appreciated that one or more features or aspects of the invention may be implemented in software, hardware or firmware, or any combination thereof. For example, one or more segments of an algorithm executable by controller 140 can be performed in separate computers, which in turn, can be communication through one or more networks.

It should be appreciated that numerous alterations, modifications, and improvements may be made to the illustrated system.

Although various embodiments exemplarily shown have been described as using sensors, it should be appreciated that the invention is not so limited. For example, rather than requiring any electronic or electromechanical sensors, the measurement of levels could alternatively be based upon the senses of an operator.

Moreover, the invention contemplates the modification of existing facilities to retrofit one or more systems, subsystems, or components and implement the techniques of the invention. Thus, for example, an existing facility including one or more installed sensors can be modified to include a controller executing instructions in accordance with one or more embodiments exemplarily discussed herein. Alternatively, existing control systems can be reprogrammed or otherwise modified to perform any one or more acts of the invention.

Having now described some illustrative embodiments of the invention, it should be apparent to those skilled in the art that the foregoing is merely illustrative and not limiting, having been presented by way of example only. Further, acts, elements, and features discussed only in connection with one embodiment are not intended to be excluded from a similar application in other embodiments.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. It is to be appreciated that various alterations, modifications, and improvements can readily occur to those skilled in the art and that such alterations, modifications, and improvements are intended to be part of the disclosure and within the spirit and scope of the invention.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used. Thus, a particular or target ratio may depend on a particular treatment facility and the scope of the invention is not limited to the above-mentioned ratios. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

What is claimed is:

1. A method of treating wastewater comprising acts of:
measuring a flow rate of the wastewater into a vessel;
immersing a membrane module in the wastewater;
air scouring the membrane module; and
regulating a rate of air scouring in proportion to the flow rate of the wastewater.

2. The method of claim 1, further comprising an act of measuring a duration during which the rate of air scouring is less than a predetermined value.

3. The method of claim 2, further comprising an act of increasing the rate of air scouring when the duration exceeds a predetermined period.

4. The method of claim 2, further comprising an act of regulating a stream of wastewater directed to the membrane module in proportion to the flow rate.

5. The method of claim 2, further comprising an act of alternating the rate of air scouring between a normal scouring rate and the regulated air scouring rate when the duration exceeds a predetermined period.

6. A wastewater treatment system comprising:
a vessel containing the wastewater;
a membrane module immersed in the wastewater;
a flow meter fluidly connected between the vessel and a source of the wastewater;
an aeration system disposed to air scour the membrane module; and
a controller in communication with the flow meter and the aeration system, and configured to generate a control signal that adjusts a rate of air scouring in proportion to a flow rate of the wastewater introduced into the vessel.

7. The wastewater treatment system of claim 6, wherein the controller is further configured to measure a duration during which the control signal is generated.

8. The wastewater treatment system of claim 7, wherein the controller is further configured to adjust the control signal to increase the rate of air scouring when the duration exceeds a predetermined period.

9. The wastewater treatment system of claim 8, further comprising a recirculation system fluidly directing wastewater to the membrane module.

10. The wastewater treatment system of claim 9, wherein the controller is further configured to adjust the rate of wastewater directed to the membrane module in proportion to the flow rate of the wastewater.

11. A wastewater treatment system comprising:
a pump disposed to introduce the wastewater into a treatment vessel;
a membrane module disposed in the treatment vessel;
an aeration system disposed to air scour the membrane module; and
a controller in communication with the pump and the aeration system and configured to regulate a rate of air scouring in proportion to a flow rate of the wastewater introduced into the treatment vessel.

12. The wastewater treatment system of claim 11, further comprising a wastewater recirculating system disposed to direct wastewater to the membrane module.

13. The wastewater treatment system of claim 12, wherein the controller is further configured to regulate the rate of wastewater directed to the membrane module based at least partially on the flow rate of the wastewater introduced into the treatment vessel.

14. A computer-readable medium having computer-readable signals stored thereon that define instructions that, as a result of being executed by a computer, instruct the computer to perform a method of controlling a wastewater treatment system having a membrane module comprising acts of:
receiving an input signal representative of a flow rate of the wastewater into the treatment system;
air scouring the membrane module; and
regulating a rate of air scouring based at least partially on the input signal.

15. The computer-readable medium of claim 14, wherein the method further comprises an act of regulating an amount wastewater directed to the membrane module by a recirculation system.

16. The computer-readable medium of claim 15, wherein the act of regulating the amount of air bubbles is performed when the input signal represents a flowrate that is less than a nominal flowrate.

17. The computer-readable medium of claim 16, wherein the act of regulating the amount of air bubbles further comprises an act of determining a duration during which the amount of air bubble generated is less than a nominal aeration rate.

18. The computer-readable medium of claim 17, wherein the act of regulating the amount of air bubbles further comprises an act of increasing the amount of air bubbles to the nominal aeration rate when the duration is greater than or equal to a predetermined period.

19. The computer-readable medium of claim 18, wherein the amount of air bubbles directed to the membrane module is proportionally based on the input signal.

20. The computer-readable medium of claim 18, wherein the amount of wastewater directed to the membrane module is proportionally based on the input signal.
